(19) United States
(12) Patent Application Publication
(10) Pub. No.: US 2026/0206038 A1
(43) Pub. Date: Jul. 16, 2026

(54) TECHNIQUES FOR MANAGING SIDELINK FEEDBACK RESOURCES ON AN UNLICENSED CARRIER

(71) Applicant: Lenovo (Singapore) Pte. Ltd., Singapore (SG)

(72) Inventors: Alexander Golitschek Edler von Elbwart, Darmstad (DE); Karthikeyan Ganesan, Nauheim (DE)

(21) Appl. No.: 19/134,667

(22) PCT Filed: Feb. 15, 2024
(86) PCT No.: PCT/IB2024/051456

§ 371 Date: May 30, 2025

Related U.S. Application Data
(60) Provisional application No. 63/485,169, filed on Feb. 15, 2023.

(51) Int. Cl. H04W 72/25

(52) U.S. Cl. CPC H04W 72/25

(57) ABSTRACT

Apparatuses, methods, and systems are disclosed for physical sidelink feedback channel (PSFCH) resource determination. One apparatus includes a processor coupled to a memory, the processor configured to cause the apparatus to select a set of PSFCH resources including at least two common PSFCH resources. The processor is configured to cause the apparatus to transmit a PSFCH transmission using the set of PSFCH resources, where an occupied channel bandwidth of the set satisfies a threshold.

### TECHNICAL FIELD

The present disclosure relates to wireless communications, and more specifically to techniques for managing (e.g., determining, identifying, allocating, handling) sidelink (SL) resources for SL communications, including a physical sidelink feedback channel (PSFCH) transmission on an unlicensed carrier.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

For SL transmissions over an unlicensed carrier (e.g., shared spectrum), regulatory bodies may require that a major part of the transmitted energy is transmitted over a minimal percentage of the assigned spectrum. However, the PSFCH structure from Third Generation Partnership Project (3GPP) Release 17 (Rel-17) SL only occupies a very small part of the assigned spectrum.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a UE comprising a means for receiving a SL configuration associated with an unlicensed carrier. The UE may comprise means for selecting a set of PSFCH resources including at least two common PSFCH resources. The UE may comprise means for transmitting a PSFCH transmission over the unlicensed carrier using the selected set of PSFCH resources, where an occupied channel bandwidth (OCB) of the selected set of PSFCH resources satisfies a threshold.

### BRIEF DESCRIPTION OF THE DRAWINGS

FIG. 1 illustrates an example of a wireless communication system in accordance with aspects of the present disclosure.

FIG. 2 illustrates an example of a protocol stack showing different protocol layers in the UE and network, in accordance with aspects of the present disclosure.

FIG. 3 illustrates an example of a sidelink protocol stack in accordance with aspects of the present disclosure.

FIG. 4 illustrates an example of PSFCH transmissions on common and dedicated resources in accordance with aspects of the present disclosure.

FIG. 5 illustrates an example of PSFCH transmissions on common and dedicated resources in accordance with aspects of the present disclosure.

FIG. 6 illustrates an example of PSFCH transmissions using common PSFCH resources aligned with the dedicated PSFCH resources in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a network equipment (NE) in accordance with aspects of the present disclosure.

FIG. 10 is a flowchart diagram illustrating one embodiment of a method for data differentiation for PSFCH resource determination in accordance with aspects of the present disclosure.

### DETAILED DESCRIPTION

The present disclosure describes systems, methods, and apparatuses for managing (e.g., determining, identifying, allocating, handling) SL resources for SL communications, including a PSFCH transmission on an unlicensed carrier. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For SL transmissions over an unlicensed carrier, regulatory bodies may require that a major part of the transmitted energy is transmitted over a minimal percentage of the assigned spectrum (“minimum bandwidth requirement,” or “OCB requirement”). Extending the PSFCH structure from Rel-17 SL to the unlicensed domain has intrinsic problems, since only a small part of the assigned spectrum would be occupied, thus violating the OCB requirement. For example, European Telecommunications Standards Institute (ETSI) European Standard (EN) 301 893 v2.1.1 Clause 4.2.2.2 defines the following requirement: “The Occupied Channel Bandwidth shall be between 80% and 100% of the Nominal Channel Bandwidth.” As used herein, “nominal channel bandwidth” (also expressed as “nominal bandwidth”) refers to the interval between the assigned frequency limits of a channel, i.e., the nominal channel bandwidth is the widest band of frequencies, inclusive of guard bands, assigned to a single channel. The Occupied Channel Bandwidth is the bandwidth containing 99% of the power of the signal.

In order to fulfill the OCB requirement, a UE is pre-configured with a set of common resources (e.g., in addition to a set of dedicated resources). In the case where the set of common resources contains a plurality of resources, it is unclear how many and which of the resources in the common resource set are used in a PSFCH transmission instance. This disclosure outlines procedures and criteria to determine which resources from the common resource set are used in a PSFCH transmission instance.

This disclosure provides solutions for managing SL feedback resources. In various embodiments, a UE is pre-configured with a set of common PSFCH resources consisting of at least two resource blocks (RBs), and with a set of dedicated PSFCH resources consisting of at least one RB, the usage of the common PSFCH resources may be necessary to fulfill regulatory requirements to distribute the transmitted signal across a certain bandwidth. At least the dedicated PSFCH resources are used to transmit Hybrid Automatic Repeat Request Acknowledgement (HARQ-ACK) information associated with one or more received transport blocks (TBs), or conflict information. As used herein, “HARQ-ACK” may represent collectively the Positive Acknowledge (ACK) and the Negative Acknowledge (NACK). ACK means that a Transport Block (TB) is correctly received while NACK means a TB is erroneously received. In the present disclosure, HARQ-ACK information may also be referred to as “HARQ feedback.”

Aspects of the present disclosure are described in the context of a wireless communications system.

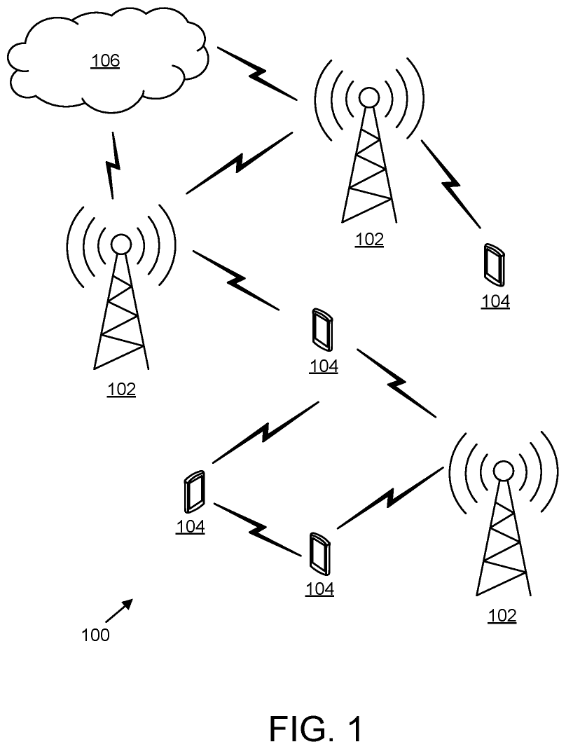

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB.

Note that with beam-based communication, each DL beam may be associated with a respective SSB. In 3GPP New Radio (NR), the gNB may transmit the maximum 64 SSBs and the maximum 64 corresponding copies of Physical Downlink Control Channel (PDCCH) and/or Physical Downlink Shared Channel (PDSCH) for delivery of System Information Block #1 (SIB1) in high frequency bands (e.g., 28 GHz).

In the following, instead of “slot,” the terms “mini-slot,” “subslot,” or “aggregated slots” can also be used, wherein the notion of slot/mini-slot/sub-slot/aggregated slots can be described as defined in 3GPP Technical Specification (TS) 38.211, TS 38.213, and/or TS 38.214. Throughout this disclosure reference to TS 38.211, TS 38.212, TS 38.213, TS 38.214 is associated with version 16.4.0 of the 3GPP specifications.

Several solutions to provide variable resource timing and size are described below. According to a possible embodiment, one or more elements or features from one or more of the described solutions may be combined.

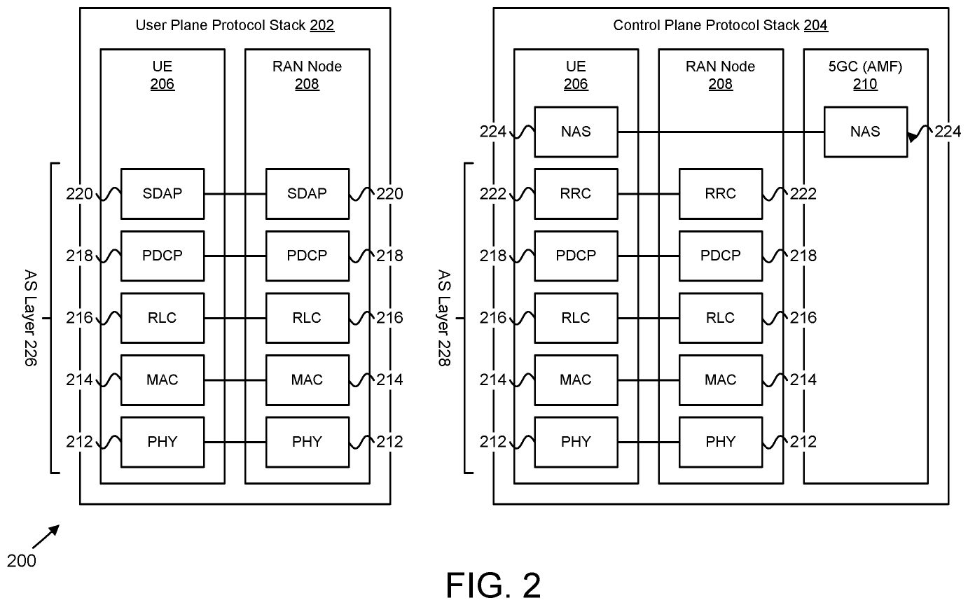

FIG. 2 illustrates an example of a protocol stack 200, in accordance with aspects of the present disclosure. In certain embodiments, the protocol stack 200 is an NR protocol stack for communication between the UE and the mobile network. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106.

As depicted, the protocol stack 200 comprises a User Plane protocol stack 202 and a Control Plane protocol stack 204. The User Plane protocol stack 202 includes a physical (PHY) layer 212, a MAC sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the protocol stack 200. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack may comprise a similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in Multiple-Input Multiple-Output (MIMO) communication (also referred to as a “MIMO layer” or a “data stream”).

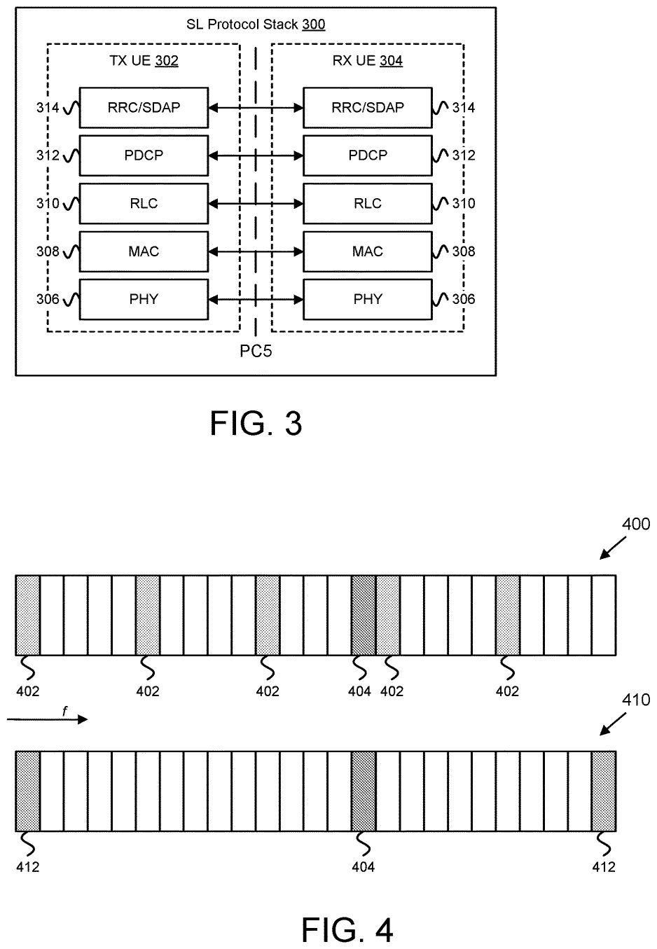

FIG. 3 depicts a sidelink (SL) protocol stack 300, in accordance with aspects of the present disclosure. While FIG. 3 shows a transmitting SL UE 302 (denoted “TX UE”) and a receiving SL UE 304 (denoted “RX UE”), these are representative of a set of UEs communicating peer-to-peer via a PC5 interface and other embodiments may involve different UEs. Each of the TX UE 302 and the RX UE 304 may be implementations of the UE 206 and/or UE 104, described above.

As depicted, the SL protocol stack 300 includes a physical layer 306, a MAC sublayer 308, a RLC sublayer 310, a PDCP sublayer 312, and RRC and SDAP layers (depicted as combined element “RRC/SDAP” 314), for the control plane and user plane, respectively. The physical layer 306, the MAC sublayer 308, the RLC sublayer 310, the PDCP sublayer 312, and the RRC/SDAP layers 314 may perform substantially the same functions described above with reference to the NR protocol stack 200 but supporting UE-to-UE communications between the TX UE 302 and the RX UE 304.

The AS protocol stack for the control plane in the SL protocol stack 300 consists of at least RRC, PDCP, RLC and MAC sublayers, and the physical layer. The AS protocol stack for the user plane in the SL protocol stack 300 consists of at least SDAP, PDCP, RLC and MAC sublayers, and the physical layer. The L2 is split into the SDAP, PDCP, RLC and MAC sublayers. The L3 includes the RRC sublayer and the NAS layer for the control plane and includes, e.g., an IP layer for the user plane. L1 and L2 are referred to as “lower layers”, while L3 and above (e.g., transport layer, V2X layer, application layer) are referred to as “higher layers” or “upper layers.”

For SL unicast transmission, an RX UE sends ACK to the TX UE if the RX UE has successfully decoded the TB carried in a Physical Sidelink Shared Channel (PSSCH); otherwise, the RX UE sends NACK to the TX UE if the RX UE has not decoded the TB after decoding the 1st-stage Sidelink Control Information (SCI). For SL groupcast transmissions, two options (option 1 and option 2) are supported for the SL Hybrid Automatic Repeat Request (HARQ) feedback in NR Vehicle-to-Everything (V2X) (note that V2X communication encompasses both Vehicle-to-Infrastructure (V2I) and Vehicle-to-Vehicle (V2V) communication). For option 1, the RX UE transmits NACK if the RX UE has not successfully decoded the TB (after decoding the 1st-stage SCI) and if its relative distance to the TX UE (referred as Tx-Rx distance) is less than or equal to the required communication range (indicated in the 2nd-stage SCI). Otherwise, the RX UE does not transmit any HARQ feedback. As the HARQ feedback for this option would only consist of NACK, option 1 is referred to as NACK-only feedback.

The PSFCH symbol that can be used for the HARQ feedback for a given PSSCH transmission corresponds to the PSFCH symbol in the first slot with PSFCH after a configured (or pre-configured) number of K slots after the PSSCH transmission (i.e., carrying the TB). Here, the parameter K represents the minimum number of slots within the resource pool between a slot with a PSSCH transmission and the slot containing PSFCH for the HARQ feedback of this transmission. Consider that the last symbol of a PSSCH transmission is on slot n. The HARQ feedback for this transmission is expected in slot n+a, where a is the smallest integer equal or higher than K such that slot n+a contains PSFCH.

As used herein, a “resource pool” refers to a set of resources assigned for SL operation. A resource pool consists of a set of RBs (i.e., Physical Resource Blocks (PRBs)) over one or more time units (e.g., subframe, slots, Orthogonal Frequency Division Multiplexing (OFDM) symbols). In some embodiments, the set of RBs comprises contiguous PRBs in the frequency domain. A Physical Resource Block (PRB), as used herein, consists of twelve consecutive subcarriers in the frequency domain.

For example, if the earliest possible slot for the HARQ feedback (slot n+a) does not contain PSFCH, then the HARQ feedback is sent at the next slot containing PSFCH (i.e., after slot n+a). The time gap of at least K slots allows considering the RX UE's processing delay in decoding the Physical Sidelink Control Channel (PSCCH) and generating the HARQ feedback. K can be equal to 2 or 3, and a single value of K can be configured (or pre-configured) per resource pool. This allows several RX UEs using the same resource pool to utilize the same mapping of PSFCH resource(s) for the HARQ feedback. With the parameter K, the N PSSCH slots associated with a slot with PSFCH can be determined. In an example with K=3, the N=4 PSSCH slots associated with the PSFCH transmission instances at slot n+6 correspond to PSSCH slots n, n+1, n+2, and n+3.

With L sub-channels in a resource pool and N PSSCH slots associated with a slot containing PSFCH, there are then N times L sub-channels associated with a PSFCH symbol. With M PRBs available for PSFCH in a PSFCH symbol, there are M PRBs available for the HARQ feedback of transmissions over N times L sub-channels. With M configured to be a multiple of N times L, then a distinct set of Mₛₑₜ=M/(N·L) PRBs can be associated with the HARQ feedback for each sub-channel within a PSFCH period.

The first set of Mₛₑₜ PRBs among the M PRBs available for PSFCH are associated with the HARQ feedback of a transmission in the first sub-channel in the first slot. The second set of Mₛₑₜ PRBs are associated with the HARQ feedback of a transmission in the first sub-channel in the second slot and so on. For example, if N=4, L=3 and with all PRBs in a PSFCH symbol available for PSFCH, the HARQ feedback for a transmission at PSSCH x is sent on the set x of Mₛₑₜ PRBs in the corresponding PSFCH symbol, with x=1, . . . , 12. For a transmission in a PSSCH with L_{PSSCH}>1 sub-channels, L_{PSSCH} times Mₛₑₜ PRBs could be available for the HARQ feedback of this transmission.

A set of Mₛₑₜ PRBs associated with a sub-channel are shared among multiple RX UEs in case of HARQ-ACK feedback for groupcast communications (option 2) or in the case of different PSSCH transmissions in the same sub-channel. For each PRB available for PSFCH, there are Q cyclic shift pairs available to support the ACK or NACK feedback of Q RX UEs within the PRB. For a resource pool, the number of cyclic shift pairs Q is configured (or pre-configured) and can be equal to 1, 2, 3 or 6.

With each PSFCH used by one RX UE, F available PSFCH transmission instances can be used for the HARQ-ACK feedback of up to F RX UEs. The F PSFCH transmission instances can be determined based on two options: either based on the L_{PSSCH} sub-channels used by a PSSCH or based only on the starting sub-channel used by a PSSCH (i.e., based only on one sub-channel for the case when L_{PSSCH}>1). Thus, F can be computed based on: (i) L_{PSSCH} sub-channels of a PSSCH; (ii) Mₛₑₜ PRBs for PSFCH associated with each sub-channel; and (iii) Q cyclic shift pairs available in each PRB.

Depending on which of two supported HARQ feedback options is configured (or pre-configured), there are either then F=L_{PSSCH}·Mₛₑₜ·Q PSFCH transmission instances (associated with the L_{PSSCH} sub-channels of a PSSCH) or F=Mₛₑₜ·Q PSFCH transmission instances (associated with the starting sub-channel of a PSSCH) available for multiplexing the HARQ feedback for the PSSCH.

Similar to the physical uplink control channel (PUCCH) in 3GPP Release 15 (Rel-15) NR on the Uu interface, the available F PSFCH transmission instances are indexed based on a PRB index (frequency domain) and a cyclic shift pair index (code domain). Depending on the configured (or pre-configured) option, there are either L_{PSSCH}·Mₛₑₜ or Mₛₑₜ PRBs available for PSFCH. The mapping of the PSFCH index i (i=1, 2, . . . , F) to the L_{PSSCH}·Mₛₑₜ or Mₛₑₜ PRBs and to the Q cyclic shift pairs is such that the PSFCH index i first increases with the PRB index until reaching the number of available PRBs for PSFCH (i.e., L_{PSSCH}·Mₛₑₜ or Mₛₑₜ). Then, the PSFCH index i increases with the cyclic shift pair index, again with the PRB index and so on.

Due to implementation constraints a UE indicates a capability by parameter psfch-FormatZeroSidelink (e.g., defined in 3GPP TS 38.331 and TS 38.306) if the UE is capable of transmitting PSFCH format 0 over the SL; in this case, the UE further indicates by parameter psfch-TxNumber (e.g., defined in 3GPP TS 38.331 and TS 38.306) the number of PSFCH(s) resources that the UE can transmit in a slot (N_{max,PSFCH}). As of NR Rel-17, this can indicate 4, 8, or 16 PSFCH transmission instances per slot.

However, it is possible that the number of scheduled PSFCH transmission instances N_{sch,Tx,PSFCH} exceeds the indicated maximum N_{max,PSFCH}. To resolve this case, the following procedure may apply.

If dl-P0-PSFCH is provided, and if N_{sch,Tx,PSFCH}≤N_{max,PSFCH} (i.e., if the number of scheduled PSFCH transmission instances is less than the indicated maximum), and if P_{PSFCH,one}+10 log₁₀(N_{sch,Tx,PSFCH})≤P_{CMAX}, where P_{CMAX} is determined for N_{sch,Tx,PSFCH} PSFCH transmissions (e.g., according to 3GPP TS 38.101), then N_{Tx,PSFCH}=N_{sch,Tx,PSFCH} and P_{PSFCH,k}(i)=P_{PSFCH,one} [dBm].

Else, (i.e., if there is insufficient power to transmit all scheduled PSFCH transmission instances) the UE autonomously determines N_{Tx,PSFCH} PSFCH transmissions first with ascending order of corresponding priority field values (e.g., as described in clause 16.2.4.2 of 3GPP TS 38.213) over the PSFCH transmissions with HARQ-ACK information, if any, and then with ascending order of priority value over the PSFCH transmissions with conflict information, if any, such that

$${N}_{Tx , PSFCH} \geq max ( 1 , {\sum }_{i = 1}^{K} {M}_{i} )$$

where Mᵢ, for 1≤i≤8, is a number of PSFCH transmission instances with priority value i for PSFCH with HARQ-ACK information and Mᵢ, for i>8, is a number of PSFCH transmission instances with priority value i−8 for PSFCH with conflict information and K is defined as the largest value satisfying

$${P}_{PSFCH , one} + 10 {log}_{10} ( max ( 1 , {\sum }_{i = 1}^{K} {M}_{i} ) ) \leq {P}_{CMAX}$$

where P_{CMAX} is determined (e.g., according to 3GPP TS 38.101) for transmission of all PSFCH transmission instances in

$${\sum }_{i = 1}^{K} {M}_{i} ,$$

if any, (otherwise K is defined as zero) and P_{PSFCH,k}(i)=min(P_{CMAX}−10 log₁₀(N_{Tx,PSFCH}), P_{PSFCH,one}) [dBm], where P_{CMAX} is defined in 3GPP TS 38.101 and is determined for the N_{Tx,PSFCH} PSFCH transmissions.

Else (i.e., if there are more scheduled PSFCH transmission instances than the indicated maximum) the UE autonomously selects N_{max,PSFCH} PSFCH transmissions with ascending order of corresponding priority field values (e.g., as described in clause 16.2.4.2 of 3GPP TS 38.213), then if P_{PSFCH,one}+10 log₁₀(N_{max,PSFCH})≤P_{CMAX}, where P_{CMAX} is determined for the N_{max,PSFCH} PSFCH transmissions (e.g., according to 3GPP TS 38.101) such that N_{Tx,PSFCH}=N_{max,PSFCH} and P_{PSFCH,k}(i)=P_{PSFCH,one} [dBm]. Otherwise, (i.e., there is insufficient power to transmit the indicated maximum number of PSFCH transmission instances) the UE autonomously selects N_{Tx,PSFCH} PSFCH transmissions in ascending order of corresponding priority field values (e.g., as described in clause 16.2.4.2 of 3GPP TS 38.213) over the PSFCH transmissions with HARQ-ACK information, if any, and then with ascending order of priority value over the PSFCH transmissions with conflict information, if any, such that

$${N}_{T x , P S F C H} \geq max ( 1 , {\sum }_{i = 1}^{K} {M}_{i} )$$

where Mᵢ, 1≤i≤8, is a number of PSFCH transmission instances with priority value i for PSFCH with HARQ-ACK information and Mᵢ, i>8, is a number of PSFCH transmission instances with priority value i−8 for PSFCH with conflict information and K is defined as the largest value satisfying

$${P}_{PSFCH , one} + 10 {log}_{10} ( max ( 1 , {\sum }_{i = 1}^{K} {M}_{i} ) ) \leq {P}_{CMAX}$$

where P_{CMAX} is determined (e.g., according to 3GPP TS 38.101) for transmission of all PSFCH transmission instances in

$${\sum }_{i = 1}^{K} {M}_{i} ,$$

if any, (and otherwise K is defined as zero) and P_{PSFCH,k}(i)=min(P_{CMAX}−10 log₁₀ (N_{Tx,PSFCH}), P_{PSFCH,one}) [dBm], where P_{CMAX} is determined for the N_{Tx,PSFCH} simultaneous PSFCH transmissions (according to 3GPP TS 38.101).

Else, P_{PSFCH,k}(i)=P_{CMAX}−10 log₁₀ (N_{Tx,PSFCH}) [dBm], where the UE autonomously determines N_{Tx,PSFCH} PSFCH transmissions with ascending order of corresponding priority field values (e.g., as described in clause 16.2.4.2 of 3GPP TS 38.213) over the PSFCH transmissions with HARQ-ACK information, if any, and then with ascending order of priority value over the PSFCH transmissions with conflict information, if any, such that N_{Tx,PSFCH}≥1 and where P_{CMAX} is determined for the N_{Tx,PSFCH} PSFCH transmissions (e.g., according to 3GPP TS 38.101).

Regarding simultaneous PSFCH transmission/reception, for a PSFCH transmission or reception with HARQ-ACK information, a priority value for the PSFCH is equal to the priority value indicated by an SCI format 1-A associated with the PSFCH.

Regarding simultaneous PSFCH transmission/reception, for a PSFCH transmission or reception with HARQ-ACK information, a priority value for the PSFCH is equal to the priority value indicated by an SCI format 1-A associated with the PSFCH.

For PSFCH transmission with conflict information, a priority value for the PSFCH is equal to the smallest priority value determined by the corresponding SCI formats 1-A for the conflicting resources.

For PSFCH reception with conflict information, a priority value for the PSFCH is equal to the priority value determined by the corresponding SCI format 1-A for the conflicting resource.

If a UE would transmit N_{sch,Tx,PSFCH} PSFCH transmission instances and receive N_{sch,Rx,PSFCH} PSFCH transmission instances, and transmissions of the N_{sch,Tx,PSFCH} PSFCH transmission instances would overlap in time with receptions of the N_{sch,Rx,PSFCH} PSFCH transmission instances, then the UE transmits or receives only a set of PSFCH transmission instances corresponding to the smallest priority field value, as determined by a first set of SCI format 1-A and/or a second set of SCI format 1-A (e.g., as defined in 3GPP TS 38.212) that are respectively associated with PSFCH transmission instances with HARQ-ACK information from the N_{sch,Tx,PSFCH} PSFCH transmission instances and PSFCH transmission instances with HARQ-ACK information from the N_{sch,Rx,PSFCH} PSFCH transmission instances when one or more of the PSFCH transmission instances provide HARQ-ACK information.

If none of the N_{sch,Tx,PSFCH} PSFCH transmission instances and none of the N_{sch,Rx,PSFCH} PSFCH transmission instances provide HARQ-ACK information, the UE transmits or receives only a set of PSFCH transmission instances corresponding to the smallest priority value of the first set of PSFCH transmission instances and the second set of PSFCH transmission instances that are respectively associated with the N_{sch,Tx,PSFCH} PSFCH transmission instances and the N_{sch,Rx,PSFCH} PSFCH transmission instances when the PSFCH transmission instances provide conflict information.

If a UE would transmit N_{sch,Tx,PSFCH} PSFCH transmission instances in a PSFCH transmission occasion, the UE first transmits PSFCH transmission instances with HARQ-ACK information from N_{Tx,PSFCH} PSFCH transmission instances corresponding to the smallest priority field values from the N_{Tx,PSFCH} priority field values. Subsequently, the UE transmits remaining PSFCH transmission instances with conflict information corresponding to the smallest remaining priority field values from the N_{Tx,PSFCH} priority field values, if any.

If a UE indicates a capability to receive N_{Rx,PSFCH} PSFCH transmission instances in a PSFCH reception occasion (e.g., as defined in 3GPP TS 38.306), the UE first receives PSFCH transmission instances with HARQ-ACK information, if any, and subsequently receives PSFCH transmission instances with conflict information, if any.

Regarding the UE procedure for transmitting PSFCH with control information, a UE can be indicated by an SCI format scheduling a PSSCH reception to transmit a PSFCH with HARQ-ACK information in response to the PSSCH reception. For the PSFCH, the UE provides HARQ-ACK information that includes ACK or NACK, or only NACK.

A UE can be provided, by parameter sl-PSFCH-Period, a number of slots in a resource pool for a period of PSFCH transmission occasion resources. If the number is zero, then PSFCH transmissions from the UE in the resource pool are disabled.

A UE can be enabled, by parameter inter-UECoordinationScheme2, to transmit a PSFCH with conflict information in a resource pool. The UE can determine, based on an indication by a SCI format 1-A, a set of resources that includes one or more slots and RBs that are reserved for PSSCH transmission. If the UE determines a conflict for a reserved resource for PSSCH transmission, then the UE provides conflict information in a PSFCH.

A UE expects that a slot

$${t}_{k}^{′ SL} ( 0 \leq k < {T}_{max}^{′} )$$

has a PSFCH transmission occasion resource if k mod

$${N}_{PSSCH}^{PSFCH} = 0 , where {t}_{k}^{′ SL}$$

is defined in 3GPP TS 38.214, and T′ₘₐₓ is a number of slots that belong to the resource pool within 10240 msec according to 3GPP TS 38.214, and

$${N}_{PSSCH}^{PSFCH}$$

is provided by parameter sl-PSFCH-Period.

A UE may be indicated by higher layers to not transmit a PSFCH that includes HARQ-ACK information in response to a PSSCH reception (e.g., as described in 3GPP TS 38.321).

If a UE receives a PSSCH in a resource pool and the HARQ feedback enabled/disabled indicator field in an associated SCI format 2-A/2-B/2-C has value 1 (e.g., as defined in 3GPP TS 38.212), then the UE provides the HARQ-ACK information in a PSFCH transmission in the resource pool. The UE transmits the PSFCH in a first slot that includes PSFCH resources and is at least a number of slots, provided by parameter sl-MinTimeGapPSFCH, of the resource pool after a last slot of the PSSCH reception.

A UE is provided by parameter sl-PSFCH-RB-Set a set of

$${M}_{PRB , set}^{PSFCH}$$

PRBs in a resource pool for PSFCH transmission with HARQ-ACK information in a PRB of the resource pool. A UE can be provided by parameter sl-PSFCH-Conflict-RB-Set a set of

$${M}_{P R B , s e t}^{P S F C H}$$

PRBs in a resource pool for PSFCH transmission with conflict information in a PRB of the resource pool. A UE expects that different PRBs are configured (or pre-configured) for conflict information and HARQ-ACK information. For a number of N_{subch} sub-channels for the resource pool, provided by parameter sl-NumSubchannel, and a number of PSSCH slots associated with a PSFCH slot that is less than or equal to

$${N}_{P S S C H}^{P S F C H} ,$$

the UE allocates the

$$[ ( i + j \cdot {N}_{P S S C H}^{P S F C H} ) \cdot {M}_{subch , slot}^{P S F C H} , ( i + 1 + j \cdot {N}_{P S S C H}^{P S F C H} ) \cdot {M}_{subch , slot}^{P S F C H} - 1 ]$$

PRBs from the

$${M}_{P R B , s e t}^{P S F C H}$$

PRBs to slot i among the PSSCH slots associated with the PSFCH slot and sub-channel j, where

$${M}_{subch , slot}^{P S F C H} = {M}_{P R B , s e t}^{P S F C H} / ( {N}_{s u b c h} \cdot {N}_{P S S C H}^{P S F C H} ) , 0 \leq i < {N}_{P S S C H}^{P S F C H} , 0 \leq j < {N}_{subch} ,$$

and the allocation starts in an ascending order of i and continues in an ascending order of j. The UE expects that

$${M}_{P R B , s e t}^{P S F C H}$$

is a multiple of

$${N}_{subch} \cdot {N}_{P S S C H}^{PSFCH} .$$

The second OFDM symbol l′ of PSFCH transmission in a slot is defined as l′=sl-StartSymbol+sl-LengthSymbols−2.

A UE determines a number of PSFCH resources available for multiplexing HARQ-ACK or conflict information in a PSFCH transmission as

$${R}_{PRB , CS}^{P S F C H} = {N}_{t y p e}^{P S F C H} \cdot {M}_{s u bch , slot}^{P S F C H} \cdot {N}_{C S}^{P S F C H} where {N}_{C S}^{P S F C H}$$

is a number of cyclic shift (CS) pairs for the resource pool provided by parameter sl-NumMuxCS-Pair and, based on an indication by parameter sl-PSFCH-CandidateResourceType. If parameter sl-PSFCH-CandidateResourceType is configured as startSubCH, then

$${N}_{type}^{P S F C H} = 1$$

and the

$${M}_{s u bch , slot}^{P S F C H}$$

PRBs are associated with the starting sub-channel of the corresponding PSSCH. If parameter sl-PSFCH-CandidateResourceType is configured as allocSubCH, then

$${N}_{type}^{PSFCH} = {N}_{s u b c h}^{PSSCH}$$

and the

$${N}_{s u b c h}^{P S S C H} \cdot {M}_{s u bch , slot}^{P S F C H}$$

PRBs are associated with the

$${N}_{s u b c h}^{PSSCH}$$

sub-channels of the corresponding PSSCH. For conflict information, the corresponding PSSCH is determined based on parameters PSFCHOccasionScheme2.

In the context of common PSFCH resources and dedicated PSFCH resources, some aspects of the common resource are as follows:

A common resource can be, e.g., a common interlace (also referred to a common “interlace pattern”), or a (plurality of) common PRBs. In certain embodiments, a PSFCH transmission may occupy a common interlace (or a portion thereof) and may include one or more dedicated PRBs. In certain embodiments, a PSFCH transmission may occupy some dedicated PRBs and some common PRBs. Further, the PSFCH transmission may (or may not) further apply code domain enhancements, such as Orthogonal Cover Code (OCC) and/or PRB-level cyclic shifts.

FIG. 4 depicts an exemplary PSFCH transmission 400 comprising a common PSFCH interlace 402 and a dedicated PRB 404. For the PSFCH transmission 400, if the dedicated PRB 404 for PSFCH and one of PRBs of the common PSFCH interlace 402 is within 1 MHz bandwidth, the transmission power will be shared between these 2 PRBs because of Power Spectral Density (PSD) limitation of regulation. In such embodiments, this can result in less transmission power of PSFCH PRB and reduce the PSFCH coverage or degrade PSFCH performance.

FIG. 4 also depicts another exemplary PSFCH transmission 410 comprising the dedicated PRB 404 and a pair of common PRBs 412. For the PSFCH transmission 410, there are common PRBs 412 configured at the edges of the RB set which can fulfill OCB requirement, i.e., the gap between these 2 PRBs is larger than 80% bandwidth. With proper configuration, the dedicated PRB 404 for the PSFCH transmission 410 and the common PRBs 412 will not be within 1 MHz bandwidth, so that the PSFCH transmission 410 can use maximum power to transmit, thereby providing better performance than the PSFCH transmission 400.

In one embodiment, each UE transmits HARQ-ACK information on one dedicated PRB 404 and additionally transmits on the common PSFCH interlace 402 to meet the OCB requirement. In such a design, all the UEs will transmit on the same common PSFCH interlace 402 (i.e., same PSFCH resource) so that the resource overhead is minimized, and their HARQ-ACK information are transmitted at different dedicated PRBs 404. However, in such a design the transmissions on common resources (i.e., the same common PSFCH interlace 402) may be wasted due to collision of multiple transmissions on the same resource.

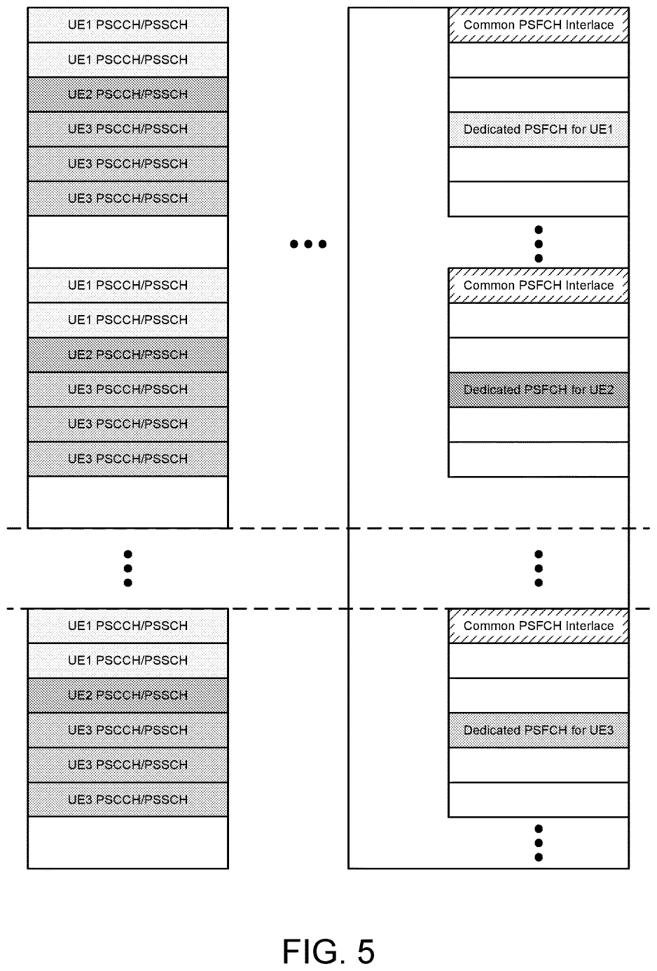

FIG. 5 depicts an example of communication resources for sidelink communication, in accordance with aspects of the present disclosure. The communication resources include a set of common PSFCH resources (i.e., PSFCH resources that may be shared among a plurality of UEs) and a set of dedicated PSFCH resources. If the UEs transmit on the same common PSFCH resource (e.g., to minimize the resource overhead), then the transmissions on the common PSFCH resources may be wasted due to collision of multiple transmissions on the same PSFCH resource. Accordingly, in other embodiments the UEs may transmit on different portions of the common interlace (rather than the same PSFCH resource) or otherwise select the common resource to improve efficiency.

In order to fulfill the OCB requirement, a UE is pre-configured with a set of common resources in addition to a set of dedicated resources. In the case where there is insufficient power for the transmission of all scheduled PSFCH transmissions (including on the common resources) or if the number of supported PSFCH transmissions is less than the number of scheduled PSFCH transmissions (including on the common resources), a procedure is necessary to determine which common resources are selected for transmission. The present disclosure describes techniques to determine which resources from the common resource set are used in a PSFCH transmission instance.

As used herein, a common PSFCH resource refers to a PSFCH resource that is configured to multiple UEs and shared by the multiple UEs. This may be established by a configuration that is applicable to a plurality of UEs, such as a parameter, e.g., in a beam-specific, cell-specific or resource pool-specific configuration. In the below descriptions, the term “common resource” refers to a common PSFCH resource, unless indicated otherwise.

In contrast, a dedicated PSFCH resource refers to a PSFCH resource that is configured to only one UE and is generally not shared among multiple UEs. This may be established by a configuration that is applicable to a single UEs, such as a parameter, e.g., in a user-specific, UE-specific or device-specific configuration. It should however be noted that as an implementation choice, two different user-specific dedicated parameters indicating a dedicated resource may indicate the same dedicated resource; the important aspect here is that the configuration of a dedicated PSFCH resource allows indication of different resources for different users, UEs, or devices. In the below descriptions, the term “dedicated resource” refers to a dedicated PSFCH resource, unless indicated otherwise.

As used herein, a PSFCH transmission instance refers to a SL transmission of information (e.g., HARQ feedback information) on the PSFCH. For example, a transmitting UE (TX UE) may transmit data to a receiving UE (RX UE) on the PSSCH. Here, the RX UE provides HARQ feedback information to the TX UE via a PSFCH transmission instance. An alternative information conveyed on PSFCH in a PSFCH transmission instance may be conflict information, e.g., as specified in 3GPP TS 38.213 v17.2.0 clause 16.3.0. In the below descriptions the term “PSFCH transmission” refers to a PSFCH transmission instance, unless indicated otherwise.

According to the solutions described herein, a communication device, such as the UE 206, is pre-configured with a set of common resources comprising at least two RBs and also pre-configured with a set of dedicated resources comprising at least one RB. At least the dedicated resources are used to transmit HARQ-ACK information associated with one or more received transport blocks, or conflict information. More generally, the common resource set is a first resource set, and the dedicated resource set is a second resource set. Thus, in the below descriptions, the terms “common” and “dedicated” are used for exemplary usage scenarios and ease of description. It should be noted that a particular resource (such as a PRB) may belong to both a common resource set and a dedicated resource set.

The usage of the common resources may be necessary to fulfill regulatory requirements to distribute the transmitted signal across a certain bandwidth. For example, for operation on unlicensed carriers (e.g., shared spectrum) ETSI EN 301 893 v2.1.1, Clause 4.2.2.2, defines the following requirement: “The Occupied Channel Bandwidth shall be between 80% and 100% of the Nominal Channel Bandwidth.”

Overall, the common resources should be defined at least per RB set. An RB set may be equivalent to an Listen-Before-Talk (“LBT”) bandwidth, i.e., the bandwidth over which a clear channel assessment (“CCA”) is performed as part of the channel access mechanism. For example, a typical RB set bandwidth is 20 MHz in the 5 GHz and 6 GHz bands.

According to an implementation, the common resource set can be given by a resource pool-specific configuration. For each RB set for which PSFCH resource is configured (or pre-configured) since each RB set needs to meet the OCB requirement.

For transmitting a PSFCH transmission instance, the UE selects at least two common resources (preferably at both ends of the spectrum) from the common resource set, and at least one dedicated resource from the dedicated resource set. The common resources are selected according to one or more of the following (which of those is selected could be up to a configuration by the resource pool or by the network).

According to embodiments of a first solution, the UE selects a common resource where at least two resources are located on opposite edges of the assigned spectrum. For example if the assigned bandwidth consists of N PRBs, then the UE selects as common resource a set of PRBs where at least one PRB is in the lower half of the N PRBs, i.e. is one of PRB indices of the interval

$$[ 0 , \frac{N - 1}{2} [$$

(i.e., the interval from 0 to (N−1)/2 that is inclusive of 0 and exclusive of (N−1)/2−rounded to integers, as appropriate), and at least one (other) PRB is in the upper half of the N PRBs, i.e. is one of PRB indices

$$\frac{N - 1}{2} , N - 1 ]$$

(i.e., the interval from (N−1)/2 to N that is exclusive of (N−1)/2 and inclusive of N−rounded to integers, as appropriate). In some embodiments, the UE selects the common resources via random selection. In a specific implementation, the selected common resource consists of exactly two PRBs. In another specific implementation, the selected common resource consists of one interlace.

According to embodiments of a second solution, the UE selects the common resources by alignment with the dedicated resource(s) allocated to the UE and selected for PSFCH transmission. This has the benefit of a low Peak to Average Power Ratio or Cubic Metric (PAPR/CM) for the overall PSFCH transmission, simplifying the implementation in hardware and/or software.

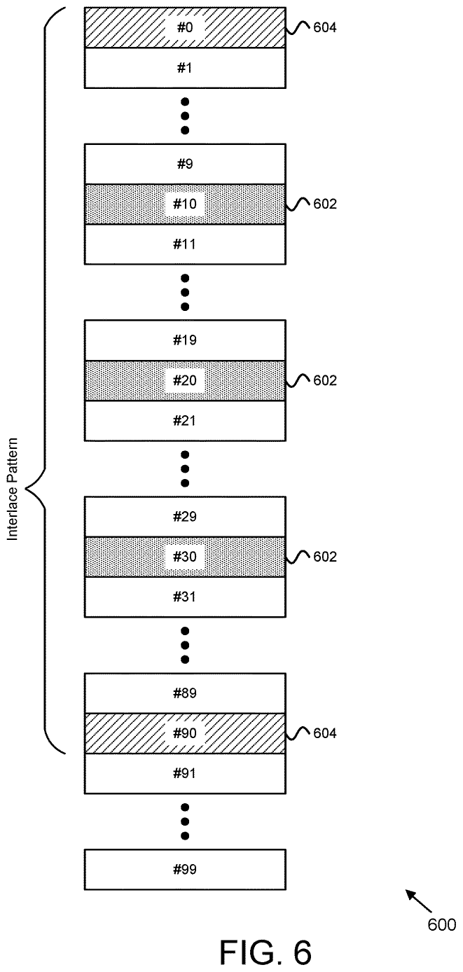

FIG. 6 depicts an exemplary PSFCH transmission 600 comprising common PSFCH resources aligned with the dedicated PSFCH resources. In the depicted example, when a PSFCH corresponds to PRBs #10, 20, 30, . . . and 80 as dedicated resources 602 for the transmission, then the UE may select PRBs #0 and 90 as common resources 604, thereby using a full interlace for transmitting a PSFCH transmission instance.

In various embodiments, if the dedicated resources occupy PRB(s) index dₖ=n+k×g, k=0, 1, . . . , K−1, then the common resources selected are PRB index c₀=n−k₀×g and PRB index c₁=n+k₁×g, where: k₀ is determined such that 0≤c₀≤g−1; k₁ is determined such that N−g≤c₁≤N−1; N is the number of PRBs in the assigned spectrum and K is the number of PRBs corresponding to a single dedicated resource, e.g., the number of PRBs in an interlace; and g is the gap (or offset) between dedicated PRBs, e.g., the interlace size.

For the specific case of using just a single PRB d as dedicated resource, i.e., K=1, the common resources selected include at least two PRBs c₀ and c₁ for which the one of the differences |c₀−d| and |c₁−d| have a common divisor greater than 1. For example, if the dedicated resource is PRB index d=24, c₀=4 and c₁=94 can be selected, as |c₀−d|=|4−24|=20 and |c₁−d|=|94−24|=70 have the common divisor 10. In a specific implementation, the common divisor is equal to the gap of an interlace, e.g., 10.

According to embodiments of a third solution, the UE selects the common resources to maximize the transmit power. This implies that the gap between a common resource PRB and the nearest neighboring dedicated PRB is larger than a pre-configured number of PRBs. In various embodiments, the UE maximizes the transmit power as a function of a pre-determined power spectral density limit per bandwidth.

If the lowest selected dedicated PRB index is PRB_{d,l} and the highest selected dedicated PRB index is PRB_{d,h}, then the UE may perform the following steps: select a first (low) common PRB index PRB_{c,l} such that PRB_{d,l}−PRB_{c,l}≥PRBₘᵢₙ; and select a second (high) common PRB index PRB_{c,h} such that PRB_{c,h}−PRB_{d,h}≥PRBₘᵢₙ.

Here, PRBₘᵢₙ is the minimum number of PRBs that are equivalent to the bandwidth for which a mean power density limit is established. For example, ETSI EN 301 893 v2.1.1 defines that for transmissions that fall completely within the band 5150 MHz to 5250 MHz the applicable limit is 10 dBm/MHz. Assuming a PRB bandwidth of 180 kHz for a subcarrier spacing of 15 kHz, the corresponding PRBₘᵢₙ can be found to be 1 MHz/180 kHz, approximately 5.6 PRBs.

In some embodiments, the value of PRBₘᵢₙ may be configured by the resource pool configuration or may be separately configured by the network. Note that in the case that just a single dedicated PRB PRB_{d} is used (e.g., for HARQ-ACK transmission), it follows that PRB_{d}=PRB_{d,l}=PRB_{d,h} in the above description.

According to embodiments of a fourth solution, the UE selects the common resources according to a priority-based selection scheme. In some embodiments, a common resource (or a common resource pair) is associated with one or more priorities. Alternatively, a priority level may be associated with a common resource (or a common resource pair).

In some embodiments, the UE selects the common resource(s) for which the associated priority matches the priority of the PSSCH corresponding to the TB for which the HARQ-ACK is to be transmitted on the PSFCH. In the case where multiple HARQ-ACK with different associated PSSCH priorities are transmitted in a PSFCH occasion, the UE selects according to the highest of those associated priorities, which may be the lowest associated priority value.

In some embodiments, the UE selects the common resource(s) for which the associated priority matches the priority given by the SCI format 1-A for a corresponding conflicting resource. In the case where multiple PSFCH transmissions with conflict information are transmitted in a PSFCH occasion, the UE selects according to the highest of those associated priorities, which may be the lowest associated priority value.

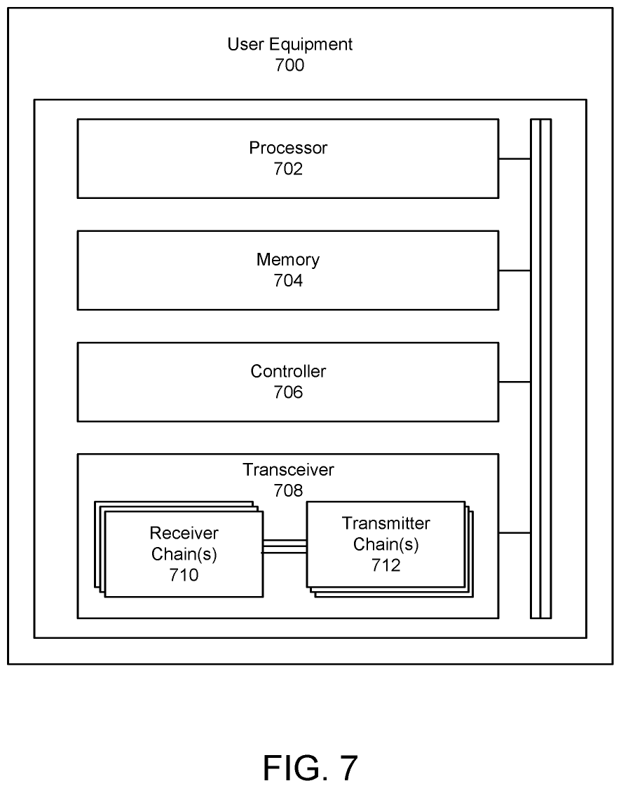

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, a Field Programable Gate Array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the UE functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving a sidelink configuration associated with an unlicensed carrier. In some embodiments, the sidelink configuration comprises a resource pool specific configuration.

The UE 700 may be configured to or operable to support a means for selecting a set of PSFCH resources comprising at least two common PSFCH resources, wherein an occupied channel bandwidth of the selected set of PSFCH resources satisfies a threshold. In some embodiments, to select the set of PSFCH resources, the UE 700 may be configured to select a first common PSFCH resource located near a first end of a nominal channel bandwidth of the unlicensed carrier and to select a second common PSFCH resource located near a second end opposite to the first end of the nominal channel bandwidth of the unlicensed carrier. In certain embodiments, the processor may be configured to randomly select the first common PSFCH resource and to randomly select the second common PSFCH resource.

In some embodiments, the selected set of PSFCH resources comprises at least two dedicated PSFCH resources having a frequency gap between the at least two dedicated PSFCH resources. In such embodiments, to select the set of PSFCH resources, the UE 700 may be configured to select the at least two common PSFCH resources based on the frequency gap between the at least two dedicated PSFCH resources. In certain embodiments, a gap between a respective dedicated PSFCH resource and a respective common PSFCH resource is a multiple of the frequency gap between the at least two dedicated PSFCH resources.

In some embodiments, the selected set of PSFCH resources comprises one dedicated PSFCH resource, wherein a first difference in frequency between the dedicated PSFCH resource and a first common PSFCH resource has a common divisor with a second difference in frequency between the dedicated PSFCH resource and a second common PSFCH resource.

In some embodiments, the UE 700 may be configured to select the common PSFCH resources to maximize a transmit power of the PSFCH transmission as a function of a pre-determined power spectral density limit per bandwidth.

In some embodiments, the UE 700 may be configured to select the common PSFCH resources according to a priority level. In certain embodiments, the PSFCH transmission is associated with a PSSCH transmission having the priority level. In such embodiments, to select the set of PSFCH resources, the UE 700 may be configured to select the at least two common PSFCH resources based on the priority level associated with the PSSCH transmission.

The UE 700 may be configured to or operable to support a means for transmitting a PSFCH transmission over the unlicensed carrier using the selected set of PSFCH resources. In some embodiments, the PSFCH transmission is associated with a plurality of PSSCH transmissions, where each PSSCH transmission is associated with a respective priority level. In such embodiments, to select the set of PSFCH resources, the UE 700 may be configured to select the at least two common PSFCH resources based on a highest priority level associated with the plurality of PSSCH transmissions.

In some embodiments, the selected set of PSFCH resources comprises at least one dedicated PSFCH resource. In some embodiments, the common PSFCH resources are associated with an interlace pattern, and wherein the selected set of PSFCH resources comprises a portion of the interlace pattern.

In some embodiments, the common PSFCH resources are defined per resource pool. In some embodiments, the common PSFCH resources are defined per RB set. In certain embodiments, the set of PSFCH resources comprises a first common PSFCH resource located near a first edge of the RB set and a second common PSFCH resource located near a second edge opposite to the first edge of the RB set.

In some embodiments, the threshold is based on a location of the UE 700. In some embodiments, the threshold corresponds to a percentage of a nominal channel bandwidth of a channel on the unlicensed carrier. In some embodiments, the threshold corresponds to a regulatory requirement. In such embodiments, the set of PSFCH resources may include a minimum set of resources blocks for satisfying the regulatory requirement.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems (OSes). In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the receiving signal and obtain the transmitted data by reversing the modulation technique applied during transmission of the signal. The receiver chain 710 may include at least one decoder for decoding and processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

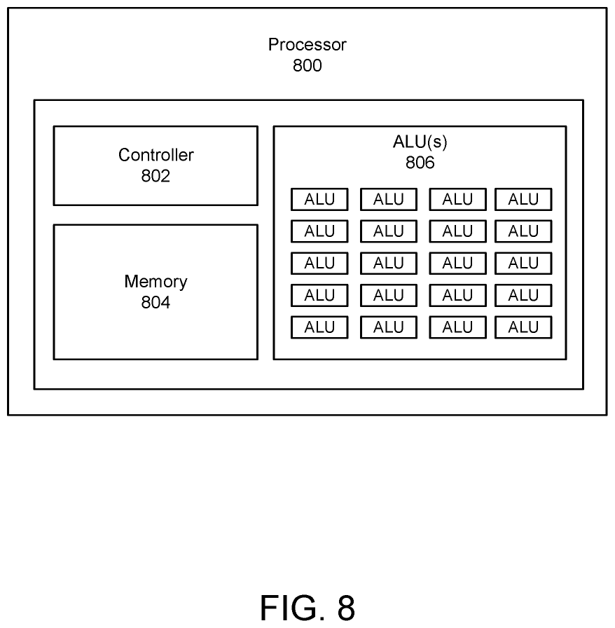

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. For example, the processor 800 may perform one or more of the UE functions described herein. The processor 800 may be configured to or operable to support a means for receiving a sidelink configuration associated with an unlicensed carrier. In some embodiments, the sidelink configuration comprises a resource pool specific configuration.

The processor 800 may be configured to or operable to support a means for receiving a sidelink configuration associated with an unlicensed carrier. In some implementations, the sidelink configuration comprises a resource pool specific configuration.

The processor 800 may be configured to or operable to support a means for selecting a set of PSFCH resources comprising at least two common PSFCH resources, wherein an occupied channel bandwidth of the selected set of PSFCH resources satisfies a threshold. In some implementations, to select the set of PSFCH resources, the processor 800 may be configured to select a first common PSFCH resource located near a first end of a nominal channel bandwidth of the unlicensed carrier and to select a second common PSFCH resource located near a second end opposite to the first end of the nominal channel bandwidth of the unlicensed carrier. In certain implementations, the processor may be configured to randomly select the first common PSFCH resource and to randomly select the second common PSFCH resource.

In some implementations, the selected set of PSFCH resources comprises at least two dedicated PSFCH resources having a frequency gap between the at least two dedicated PSFCH resources. In such implementations, to select the set of PSFCH resources, the processor 800 may be configured to select the at least two common PSFCH resources based on the frequency gap between the at least two dedicated PSFCH resources. In certain implementations, a gap between a respective dedicated PSFCH resource and a respective common PSFCH resource is a multiple of the frequency gap between the at least two dedicated PSFCH resources.

In some implementations, the selected set of PSFCH resources comprises one dedicated PSFCH resource, wherein a first difference in frequency between the dedicated PSFCH resource and a first common PSFCH resource has a common divisor with a second difference in frequency between the dedicated PSFCH resource and a second common PSFCH resource.

In some implementations, the processor 800 may be configured to select the common PSFCH resources to maximize a transmit power of the PSFCH transmission as a function of a pre-determined power spectral density limit per bandwidth.

In some implementations, the processor 800 may be configured to select the common PSFCH resources according to a priority level. In certain implementations, the PSFCH transmission is associated with a PSSCH transmission having the priority level. In such implementations, to select the set of PSFCH resources, the processor 800 may be configured to select the at least two common PSFCH resources based on the priority level associated with the PSSCH transmission.

The processor 800 may be configured to or operable to support a means for transmitting a PSFCH transmission over the unlicensed carrier using the selected set of PSFCH resources. In some implementations, the PSFCH transmission is associated with a plurality of PSSCH transmissions, where each PSSCH transmission is associated with a respective priority level. In such implementations, to select the set of PSFCH resources, the processor 800 may be configured to select the at least two common PSFCH resources based on a highest priority level associated with the plurality of PSSCH transmissions.

In some implementations, the selected set of PSFCH resources comprises at least one dedicated PSFCH resource. In some implementations, the common PSFCH resources are associated with an interlace pattern, and wherein the selected set of PSFCH resources comprises a portion of the interlace pattern.

In some implementations, the common PSFCH resources are defined per resource pool. In some implementations, the common PSFCH resources are defined per RB set. In certain implementations, the set of PSFCH resources comprises a first common PSFCH resource located near a first edge of the RB set and a second common PSFCH resource located near a second edge opposite to the first edge of the RB set.

In some implementations, the threshold is based on a location of the processor 800. In some implementations, the threshold corresponds to a percentage of a nominal channel bandwidth of a channel on the unlicensed carrier. In some implementations, the threshold corresponds to a regulatory requirement. In such implementations, the set of PSFCH resources may include a minimum set of resources blocks for satisfying the regulatory requirement.

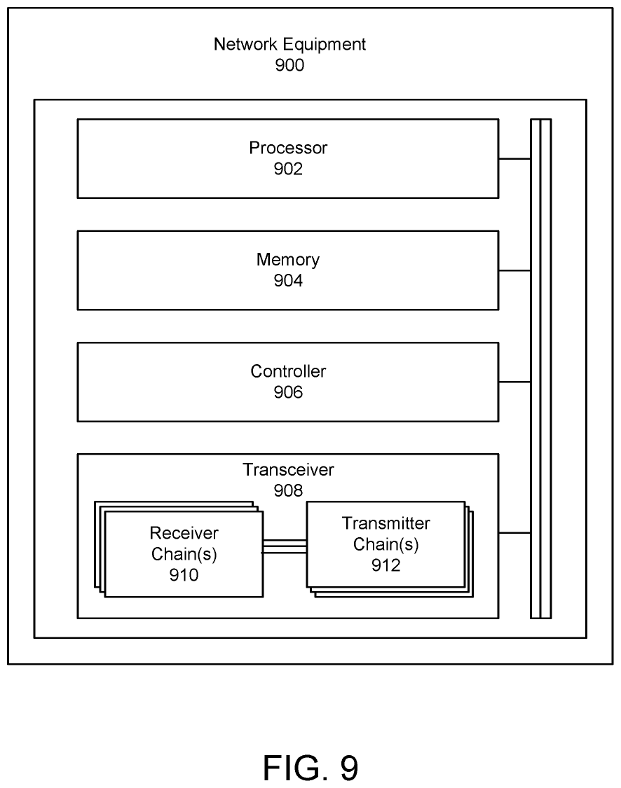

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein.

The controller 906 may manage input and output signals for the NE 900. The controller 906 may also manage peripherals not integrated into the NE 900. In some implementations, the controller 906 may utilize an OS such as iOS®, ANDROID®, WINDOWS®, or other OSes. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the receiving signal and obtain the transmitted data by reversing the modulation technique applied during transmission of the signal. The receiver chain 910 may include at least one decoder for decoding and processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

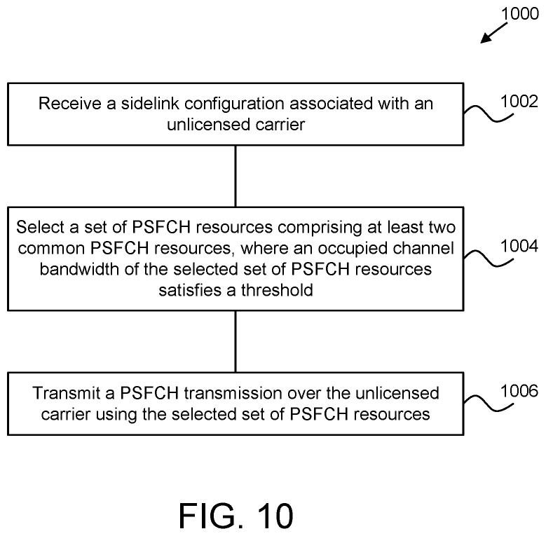

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At Step 1002, the method 1000 may include receiving a sidelink configuration associated with an unlicensed carrier. The operations of Step 1002 may be performed in accordance with examples as described herein. In some implementations, aspects of the operations of Step 1002 may be performed by a UE as described with reference to FIG. 7.

At Step 1004, the method 1000 may include selecting a set of PSFCH resources comprising at least two common PSFCH resources, wherein an occupied channel bandwidth of the selected set of PSFCH resources satisfies a threshold. The operations of Step 1004 may be performed in accordance with examples as described herein. In some implementations, aspects of the operations of Step 1004 may be performed by a UE as described with reference to FIG. 7.

At Step 1006, the method 1000 may include transmitting a PSFCH transmission over the unlicensed carrier using the selected set of PSFCH resources. The operations of Step 1006 may be performed in accordance with examples as described herein. In some implementations, aspects of the operations of Step 1006 may be performed by a UE as described with reference to FIG. 7.

It should be noted that the method 1000 described herein describes one possible implementation, and that the operations and the steps may be rearranged or otherwise modified and that other implementations are possible.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
select a set of physical sidelink feedback channel (PSFCH) resources comprising at least two common PSFCH resources, wherein an occupied channel bandwidth of the set of PSFCH resources satisfies a threshold; and
transmit a PSFCH transmission using the set of PSFCH resources.

2. The UE of claim 1, wherein to select the set of PSFCH resources, the at least one processor is configured to cause the UE to:
select a first common PSFCH resource located near a first end of a nominal channel bandwidth, or
select a second common PSFCH resource located near a second end opposite to the first end of the nominal channel bandwidth.

3. The UE of claim 1, wherein the set of PSFCH resources comprises at least two dedicated PSFCH resources having a frequency gap between the at least two dedicated PSFCH resources, and wherein to select the set of PSFCH resources, the at least one processor is configured to cause the UE to:
select the at least two common PSFCH resources based on the frequency gap between the at least two dedicated PSFCH resources,
wherein a respective gap between a respective dedicated PSFCH resource and a respective common PSFCH resource is a multiple of the frequency gap between the at least two dedicated PSFCH resources.

4. The ULE of claim 1, wherein the set of PSFCH resources comprises one dedicated PSFCH resource, wherein a first difference in frequency between the dedicated PSFCH resource and a first common PSFCH resource has a common divisor with a second difference in frequency between the dedicated PSFCH resource and a second common PSFCH resource.

5. The UE of claim 1, wherein the at least one processor is configured to cause the UE to select the at least two common PSFCH resources to maximize a transmit power of the PSFCH transmission as a function of a pre-determined power spectral density limit per bandwidth.

6. The UE of claim 1, wherein the at least one processor is configured to cause the UE to:
select the at least two common PSFCH resources according to a priority level,
wherein the PSFCH transmission is associated with a physical sidelink shared channel (PSSCH) transmission having the priority level, and
wherein the set of PSFCH resources is selected based on the priority level associated with the PSSCH transmission.

7. The UE of claim 1, wherein the PSFCH transmission is associated with a plurality of physical sidelink shared channel (PSSCH) transmissions, wherein each PSSCH transmission is associated with a respective priority level, and wherein the set of PSFCH resources is selected based on a highest priority level associated with the plurality of PSSCH transmissions.

8. The UE of claim 1, wherein the at least two common PSFCH resources are associated with an interlace pattern, and wherein the set of PSFCH resources comprises a portion of the interlace pattern.

9. The UE of claim 1, wherein the at least one processor is configured to cause the UE to receive a sidelink configuration associated with an unlicensed carrier, wherein the sidelink configuration comprises a resource pool specific configuration, and wherein the at least two common PSFCH resources are defined per resource pool.

10. The UE of claim 1, wherein the at least two common PSFCH resources are defined per resource block (RB) set, wherein the set of PSFCH resources comprises a first common PSFCH resource located near a first edge of the RB set and a second common PSFCH resource located near a second edge opposite to the first edge of the RB set.

11. The UE of claim 1, wherein the threshold is based on a percentage of a nominal channel bandwidth of a channel on an unlicensed carrier, or is based on a location of the UE, or both.

12. The UE of claim 1, wherein the threshold corresponds to an occupied channel bandwidth (OCB) requirement.

13. A processor for wireless communication, comprising:
at least one controller coupled with at least one memory and configured to cause the processor to:
select a set of physical sidelink feedback channel PSFCH resources comprising at least two common PSFCH resources, wherein an occupied channel bandwidth of the set of PSFCH resources satisfies a threshold; and
transmit a PSFCH transmission using the set of PSFCH resources.

14. The processor of claim 13, wherein to select the set of PSFCH resources, the at least one controller is configured to cause the processor to:
select a first common PSFCH resource located near a first end of a nominal channel bandwidth, or
select a second common PSFCH resource located near a second end opposite to the first end of the nominal channel bandwidth.

15. The processor of claim 13, wherein the set of PSFCH resources comprises at least two dedicated PSFCH resources having a frequency gap between the at least two dedicated PSFCH resources, and wherein to select the set of PSFCH resources, the at least one controller is configured to cause the processor to:
select the at least two common PSFCH resources based on the frequency gap between the at least two dedicated PSFCH resources,
wherein a respective gap between a respective dedicated PSFCH resource and a respective common PSFCH resource is a multiple of the frequency gap between the at least two dedicated PSFCH resources.

16. The processor of claim 13, wherein the set of PSFCH resources comprises one dedicated PSFCH resource, wherein a first difference in frequency between the dedicated PSFCH resource and a first common PSFCH resource has a common divisor with a second difference in frequency between the dedicated PSFCH resource and a second common PSFCH resource.

17. The processor of claim 13, wherein the at least one controller is configured to cause the processor to select the at least two common PSFCH resources to maximize a transmit power of the PSFCH transmission as a function of a pre-determined power spectral density limit per bandwidth.

18. The processor of claim 13, wherein the at least one controller is configured to cause the processor to:
select the at least two common PSFCH resources according to a priority level,
wherein the PSFCH transmission is associated with a physical sidelink shared channel (PSSCH) transmission having the priority level, and
wherein the set of PSFCH resources is selected based on the priority level associated with the PSSCH transmission.

19. The processor of claim 13, wherein the PSFCH transmission is associated with a plurality of physical sidelink shared channel (PSSCH) transmissions, wherein each PSSCH transmission is associated with a respective priority level, and wherein the set of PSFCH resources is selected based on a highest priority level associated with the plurality of PSSCH transmissions.

20. The processor of claim 13, wherein the at least two common PSFCH resources are associated with an interlace pattern, and wherein the set of PSFCH resources comprises a portion of the interlace pattern.
